(19) United States
(12) Patent Application Publication
(10) Pub. No.: US 2006/0259585 A1
(43) Pub. Date: Nov. 16, 2006

(54) Enabling user selection of web page position download priority during a download

(75) Inventors: Susann M. Keohane, Austin, TX (US); Gerald F. McBrearty, Austin, TX (US); Shawn P. Mullen, Buda, TX (US); Jessica Murillo, Round Rock, TX (US); Johnny M. Shieh, Austin, TX (US)

Correspondence Address: IBM CORP (AP);C/O AMY PATTILLO, P. O. BOX 161327, AUSTIN, TX, 78716, US

(73) Assignee: International Business Machines Corporation, Armonk, NY (US)

(21) Appl. No.: 11/126,122

(22) Filed: May 10, 2005

(51) Int. Cl. G06F 15/16

(52) U.S. Cl. 709/219

(57) ABSTRACT

A method, system, and program for enabling user selection of web page position download priority during a download are provided. A client system is communicatively connected via a network to a server system that downloads a web page by sequentially sending each of a plurality of portions of data that specify the web page. The client system detects receipt of a first portion of data from among a plurality of portions of data for specifying the web page. The client system controls display of the first portion of data, as it is received, within a window area of a user interface formatted for displaying the web page. The client system detects, while still communicatively connected to the server system and receiving the first portion of data, a selection by a user of a particular position within the window area. The client system then calculates offsets for defining the particular position and sends a request to the server system to adjust the download so that the next portion of data sent during the download specifies the particular position within the window area.

### BACKGROUND OF THE INVENTION

1. Technical Field

The present invention relates in general to improved web browsing and in particular to enabling a user selection of a web page position download priority during a download. Still more particularly, the present invention relates to detecting a user selection of a particular position not yet completed within a web page display window while a web page is downloading and sending a request for the web server to next send the portion of the web page that includes the particular position, wherein the web server then adjusts the web page download so that the next portion of the web page sent to the client includes the portion of the web page at the user selected position.

2. Description of the Related Art

Network environments, such as the Internet network environment, facilitate transfer of data from one computing system to another computing system. In many network environments, the computing system providing the data may be referred to as a server and the computing system requesting and receiving the data may be referred to as a client.

In the Internet network environment, a client requests access to a web page stored on a server using a particular protocol, such as the Hypertext Transfer Protocol (HTTP). A web page may include a file written in the Hypertext Markup Language (HTML) or the extensible markup language (XML) that describes the formatting and contents of the web page. The description of the contents of a web page may include text, graphics, images, audio, video, Java applets (Java is a registered trademark of Sun Microsystems Inc.), and other document and application types. In addition, the file for one web page may include a link, that when selected by the user, triggers a request for access to another web page.

When a server receives a request for access to a web page, the server hosting the web page locates the requested web page and begins to download the web page to the client via the network. In particular, in the Internet network environment, data is transferred in network packets of a maximum transmission unit (MTU) transfer size, where each packet includes addressing and all or a portion of the data for a web page. Therefore, in the Internet network environment, if the web page file is larger than the transfer size, the server breaks the web page into packets of data of a particular size, such as the MTU, for transfer to the client during a download in multiple packets.

A web browser running on a client system provides one type of user interface for a user to request access to a particular web page and to control the display of a web page as the data for the web page is downloaded. In particular, one function of a web browser is to detect the formatting required for a web page from the web page file and control the rendering of a web page with the formatting. First, the web browser may detect the display size of a web page and adjust scroll bars of a browser window to enable scrolling to the portions of the web page larger than the browser window size. Next, the web browser controls display of the portions of the web page within the browser window as each portion is received during the download.

As the size of the data in a web page file increases, the time required to download a web page increases and the number of packets required in a download increases. In particular, when a web page includes data intensive content, such as a Java applet, jpeg, or gif, the download and rendering of the web page content within a graphical display area may be time intensive.

Long download times are particularly disadvantageous when a user is accessing a first web page just to select a link to another web page and the link will not load until large graphics first load. For example, many users set a home web page that is automatically triggered for access when a new browser window opens. A home web page may include links that the user often selects to navigate to other web pages, such as a web page listing current stock prices. Thus, a user becomes familiar with the web page and the position of selectable links within the web page, but when those links are located farther down the web page than multiple ads and other graphics, the user must wait for the prior portions of the web page to load before the selectable links are loaded and displayed.

One solution to the problem of accessing a second web page through a link on a first web page that is slow to load is setting a bookmark in the web browser to the second page. The user then selects the bookmark from a pulldown menu, rather than from the first web page, for the next access. Bookmarking, however, is a limited solution because the data on many web pages and the web page itself is often temporary; the information available on a web page one day may be located on a different web page at a different address on another day. Additionally, bookmarking is limited because a first web page may include many links that are already topically organized, where a user would prefer to access web pages links through the first page as the links than to take the extra step of accessing each web page a first time, set a bookmark, and then organize the bookmarks.

One solution to the problem of slow downloads is to send data for lower resolution output of images on the web page first and then to send data to describe a higher resolution output second. While, first downloading lower resolution images is faster than downloading a high resolution image, the user may access the page only to view one particular image on the page and disadvantageously still has to wait for all the other images to first load in low resolution and then in higher resolution. For example, a user may access a weather page that includes weather maps of certain areas of the United States, but only wants to look at a weather map that includes Texas that the user knows is in a particular position towards the bottom of the page; with a lower resolution download first, the user must wait for all the images on the page to first load in low resolution and then load in high resolution, just to view a high resolution image of the weather map that includes Texas.

In view of the foregoing, it would be advantageous to provide a method, system, and program for enabling a user to specify, during a download of a web page, a particular range or position within the web page to download next and for the server delivering the web page to next deliver the contents of the web page in the particular range or position within the web page. Further, it would be advantageous to provide a method, system, and program for enabling a user, through cursor based input, to indicate a priority for downloading links or a high resolution image while the web page is downloading, where the user knows the position of the link or image within a particular area of a frequently visited web page.

### SUMMARY OF THE INVENTION

Therefore, the present invention provides improved web browsing and in particular provides an improved method, system, and program for enabling a user selection of a web page position download priority during a download of a web page. Still more particularly, the present invention provides a method, system, and program for detecting a user selection of a particular position not yet completely downloaded within a web page display area while a web page is downloading and sending a request for the web server to next send the portion of the web page that includes the particular position, wherein the web server then adjusts the web page download so that the next portion of the web page sent to the client includes the portion of the web page at the user selected position.

In one embodiment, a client system is communicatively connected via a network to a server system that downloads a web page by sequentially sending each of a plurality of portions of data that specify the web page. The client system detects receipt of a first portion of data from among a plurality of portions of data for specifying the web page. The client system controls display of the first portion of data, as it is received, within a window area of a user interface formatted for displaying the web page. The client system detects, while still communicatively connected to the server system and receiving the first portion of data, a selection by a user of a particular position within the window area. The client system then calculates offsets for defining the particular position and sends a request to the server system to adjust the download so that the next portion of data sent during the download specifies the particular position within the window area.

The client system may detect a user selection of a particular position within the window area by detecting a position of a cursor within the window area and a selection by the user of the cursor position and specifying the particular position based on a horizontal offset of the position of the cursor from a top edge of the window area. In addition, the client system may detect a user selection of a particular position within the window area by detecting a selection of a user to open a menu of selectable positions, opening the menu, detecting a user selection from the menu, and setting the user selection from the menu as the particular position. The menu may include selections such as a quadrant or side of the window area or selections of tools for specifying an section of the window area. Further, the client system may detect a user selection of a particular position within the window area by detecting an adjustment of a position within an audio transmission bar and specifying the particular position by the offset of the position within the audio transmission bar. Moreover, the client system may detect a user selection of a cursor pointing to an image and specify the particular position as the position of image with a request for high resolution output of the image.

The server system that downloads the web page to the client system receives the request to adjust the download, calculates a location within a web page file that matches the particular position in the request, and sends a next portion of the data from the new location within the web page file. The client system detects that the data received from the server system is the next portion of data for specifying the particular position of the web page and controls display of the next portion of data within the window area as the data is received at the client system.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram depicting a computer system in which the present method, system, and program may be implemented;

FIG. 2 is a block diagram depicting a network environment for supporting web communications;

FIG. 3 is a block diagram depicting the interoperation of a web browser within a client system;

FIG. 4 is an illustrative diagram depicting one example of the flow of data between a web browser and a web server where user specified download priority is enabled;

FIGS. 5A-5b are illustrative diagrams depicting options for download priority selection within a browser window by a user;

FIG. 6 is an illustrative diagram depicting download priority selection within an audio/video interface of a browser window by a user;

FIG. 7 is a high level logic flowchart depicting a process and program for a web browser response to user download priority selections; and

FIG. 8 is a high level logic flowchart depicting a process and program for a web server response to a download parameter request for a currently downloading web page.

### DETAILED DESCRIPTION OF THE PREFERRED EMBODIMENT

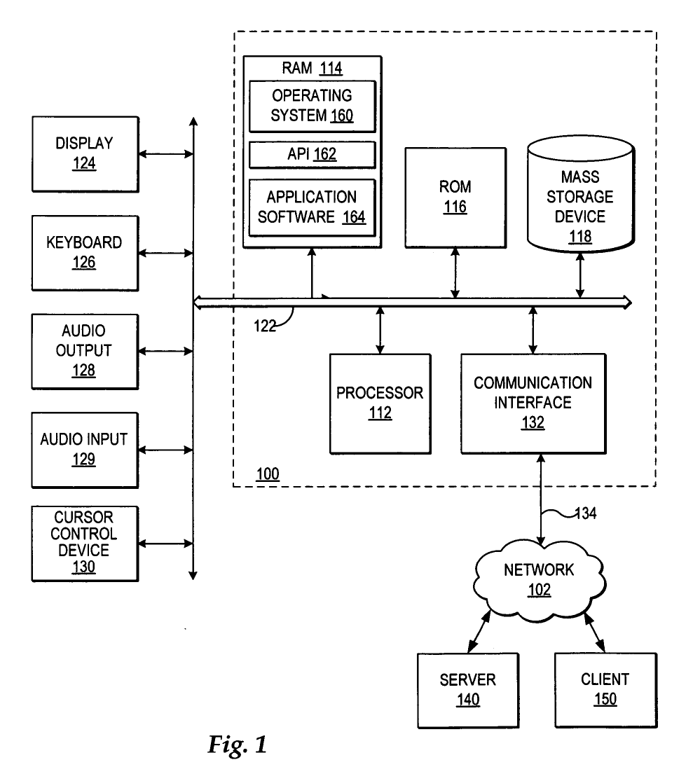

Referring now to the drawings and in particular to FIG. 1, there is depicted one embodiment of a computing system through which the present method, system, and program may be implemented. The present invention may be executed in a variety of systems, including a variety of computing systems and electronic devices.

Computer system 100 includes a bus 122 or other communication device for communicating information within computer system 100, and at least one processing device such as processor 112, coupled to bus 122 for processing information. Bus 122 preferably includes low-latency and higher latency paths that are connected by bridges and adapters and controlled within computer system 100 by multiple bus controllers. When implemented as a server system, computer system 100 typically includes multiple processors designed to improve network servicing power.

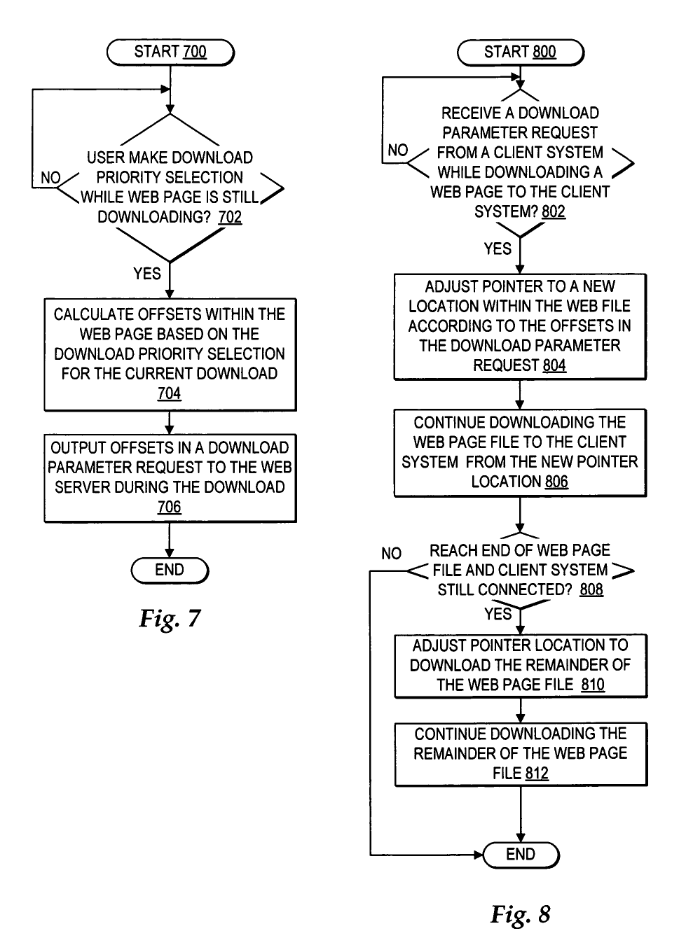

Processor 112 may be a general-purpose processor such as IBM's PowerPC (PowerPC is a registered trademark of International Business Machines Corporation) processor that, during normal operation, processes data under the control of an operating system 160 and application software 164 accessible from a dynamic storage device such as random access memory (RAM) 114. Although not depicted, operating system 160 and application software 164 may also be accessible from static storage device such as Read Only Memory (ROM) 116. The operating system 160 facilitates a graphical user interface (GUI) via a display 124 and other output interfaces. In one embodiment, application software 164 contains machine executable instructions that when executed on processor 112 carry out the operations depicted in the flowcharts of FIGS. 7 and 8 and other operations described herein. Alternatively, the steps of the present invention might be performed by specific hardware components that contain hardwired logic for performing the steps, or by any combination of programmed computer components and custom hardware components. Additionally, RAM 114 may include an application programming interface (API) 162 or other interface that provides extensions to enable application developers to develop application software 164 that extend the functionality of operating system 160.

The present invention may be provided as a computer program product, included on a machine-readable medium having stored thereon the machine executable instructions used to program computer system 100 to perform a process according to the present invention. The term “machine-readable medium” as used herein includes any medium that participates in providing instructions to processor 112 or other components of computer system 100 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 100 can read and which is suitable for storing instructions. In the present embodiment, an example of a non-volatile medium is mass storage device 118 which as depicted is an internal component of computer system 100, but will be understood to also be provided by an external device. Volatile media include dynamic memory such as RAM 114. Transmission media include coaxial cables, copper wire or fiber optics, including the wires that comprise bus 122. Transmission media can also take the form of acoustic or light waves, such as those generated during radio frequency or infrared data communications.

Moreover, the present invention may be downloaded as a computer program product, wherein the program instructions may be transferred from a remote computer such as a server 140 to requesting computer system 100 by way of data signals embodied in a carrier wave or other propagation medium via a network link 134 (e.g. a modem or network connection) to a communications interface 132 coupled to bus 122. Communications interface 132 provides a two-way data communications coupling to network link 134 that may be connected, for example, to a local area network (LAN), wide area network (WAN), or directly to an Internet Service Provider (ISP). In particular, network link 134 may provide wired and/or wireless network communications to one or more networks.

Network link 134 in turn provides data communication services through network 102. Network 102 may refer to the worldwide collection of networks and gateways that use a particular protocol, such as Transmission Control Protocol (TCP) and Internet Protocol (IP), to communicate with one another. Network link 134 and network 102 both use electrical, electromagnetic, or optical signals that carry digital data streams. The signals through the various networks and the signals on network link 134 and through communication interface 132, which carry the digital data to and from computer system 100, are exemplary forms of carrier waves transporting the information.

When implemented as a server system, computer system 100 typically includes multiple communication interfaces accessible via multiple peripheral component interconnect (PCI) bus bridges connected to an input/output controller. In this manner, computer system 100 allows connections to multiple network computers, such as client 150, via network 102.

In addition, computer system 100 typically includes multiple peripheral components that facilitate communication. These peripheral components are connected to multiple controllers, adapters, and expansion slots coupled to one of the multiple levels of bus 122. For example, an audio output device 128 and audio input device 129 are connectively enabled on bus 122 for controlling audio outputs and inputs. A display device 124 is also connectively enabled on bus 122 for providing visual, tactile or other graphical representation formats and a cursor control device 130 is connectively enabled on bus 122 for controlling the location of a pointer within display device 124. A keyboard 126 is connectively enabled on bus 122 as an interface for user inputs to computer system 100. In alternate embodiments of the present invention, additional input and output peripheral components may be added.

Those of ordinary skill in the art will appreciate that the hardware depicted in FIG. 1 may vary. Furthermore, those of ordinary skill in the art will appreciate that the depicted example is not meant to imply architectural limitations with respect to the present invention.

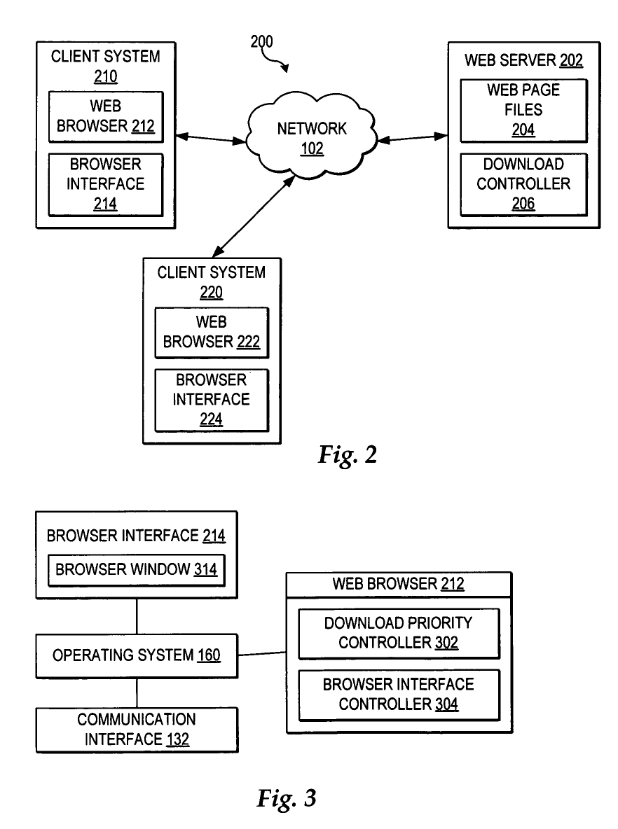

With reference now to FIG. 2, a block diagram depicts a network environment for supporting web communications in accordance with the method, system, and program of the present invention. As illustrated, a distributed network 200 is a network of multiple computer systems, such as computer system 100, through which web pages are accessed and downloaded. In alternate embodiments, distributed network 200 may include other embodiments of computing systems enabled to communicate with one another via a connection.

In the embodiment, distributed network 200 includes network 102, which is the medium used to provide communications links between various devices and computer connected together within distributed network 200. Network 102 may include permanent connections such as wire or fiber optics cables and temporary connections made through telephone connections and wireless transmission connections, for example.

In particular, in the embodiment, distributed network 200 includes at least one server, such as web server 202, and at least one client, such as client systems 210 and 220 communicatively connected via network 102. It will be understood that each of web server 202 and client systems 210 and 220 may be distributed in geographically disparate locations throughout heterogeneous types of computer systems operating within disparate local networks. In addition, it will be understood that web server 202 may represent a single server system, a cluster of server systems, a grid of server systems, or other combination of systems providing access to a particular web page or multiple web pages. In addition, it will be understood that distributed network 200 may include additional servers, clients, and other devices not shown.

Web server 202 and client systems 210 and 220 may communicate within distributed network 200 in conformance with different network environment architectures. In the embodiment depicted, distributed network 200 conforms to a client/server network architecture where web server 202 performs as a server for providing web services to client system 210 and client system 220 responsive to requests for web services from client system 210 and client system 220. In facilitating the client/server environment, in one example, network 102 represents the worldwide collection of networks and gateways that use the TCP/IP suite of protocols to communicate with one another. In another example, network 102 is implemented as an intranet, a local area network (LAN), or a wide area network (WAN). It will be understood that distributed network 200 may conform to other network environments or a combination of multiple types of network environments. Further, it will be understood that in the client/server environment, any of client systems 210 and 220 may perform as a “server” if providing web services to another computer system via network 102. Additionally, it will be understood that distributed network 200 may support peer-to-peer network communications between client system 210 and client system 220, where one client system distributes a web page to another client system.

Although not depicted in FIG. 2, following the description of computing system 100, in general, web server 202 includes at least one processor and memory for supporting an operating system, APIs, and application programs. In addition, web server 202 may include middleware applications loaded into memory that support server functions, where the middleware applications may include, for example, IBM's Websphere or NetFinity (Websphere and NetFinity are registered trademarks of International Business Machines Corporation).

As depicted, specifically, web server 202 includes or accesses web page files 204. Web page files 204 include at least one web page stored in or across at least one data storage system or memory accessible to web server 202. In particular, a web page is a document consisting of a particular web protocol based file, with associated files for graphics, embedded audio and video players, and scripts, in a particular directory, such as web page files 204, on a particular server system, such as web server 202. A web page may be identified and requested by a uniform resource locator (URL), where the URL specifies the protocol to be used in accessing the web page and the name of the web server on which the web page resides (e.g. web server 202 is registered with network 102 through a particular URL in the example). In addition, a web page may include selectable links to other web pages located on the same web server or another web server.

In addition, as depicted, specifically, web server 202 includes a download controller 206. The functions of download controller 206 may be distributed across one or more of the operating system, middleware applications, or application programs of web server 202. In particular, download controller 206 facilitates opening separate communication channels between web server 202 and client systems 210 and 220 and downloading web pages from web page files 204 to client systems 210 and 220. In addition, according to an advantage, download controller 206 receives requests for changes in download parameters from client systems 210 and 220, determines a new location within a web page file according to the download parameters, and continues the download from the new location within a web page file.

In one embodiment, in general, client system 210 and client system 220 request access to a web page from web server 202 by requesting accessing to a web page at a particular URL. In particular, client system 210 and client system 220 may concurrently send requests for access to the same web page from web server 202. Download controller 206 controls a separate download of the same web page to each of client systems 210 and 220.

Once download controller 206 locates a requested web page, download controller 206 sets a pointer to the beginning of the web page file for the requesting client system and begins downloading the web page contents to each requesting client system. In particular, downloading the web page may include breaking the web page file and associated content into packets or blocks of data for transmission to each of client systems 210 and 220. In one embodiment, the web page contents are sent in packets that sequentially specify the web page from top to bottom. In another embodiment, the web page contents are sent in packets that sequentially specify a low resolution output of the web page from top to bottom and then sequentially specify a high resolution output of the web page from top to bottom. It will be understood that other packet ordering of web page content output may be specified.

In one embodiment, client systems 210 and 220 include web browsers 212 and 222, respectively, where a web browser is application software that facilitates web page access requests and the display of accessed web pages through a browser interface 214 or 224, for example. In one example, browser interface 214 or 224 includes a browser window displayed within a GUI. In another example, browser interface 214 or 224 may include an audio interface where the contents of a web page are output in an audible format. A browser interface, such as browser interface 214 or 224, may be supported by an operating system (not depicted) and controlled by web browser 212 or 222, for example. It will be understood that web browsers 212 and 222 may be integrated within an operating system, such as operating system 160, or other application software or may function as stand-alone application software. In addition, it will be understood that browser interfaces 214 and 224 may be incorporated within a user interface consisting of the peripherals accessible to each client system.

In particular, requests for access to a web page from web browser 212 may be triggered multiple ways. In one example, a user enters a URL for a web page through the browser window or selects a link to another web page within the browser window to trigger a request for access to another web page. In another example, web browser 212 automatically triggers a request for access to a particular URL when a new browser window is opened, for example.

In addition, in particular, during a web page download to client system 210, for example, web server 202 passes formatting information about a web page to client system 210. Formatting information may include the size of the web page framing and the size of the full download, for example. Web browser 212 uses the formatting information to set up the browser window, for example, to receive the content of the web page.

According to an advantage, while web server 202 is downloading a web page to a client system, such as client system 210, client system 210 may send a request to adjust the position within the web page from which the downloading continues in a download parameter request. For example, client system 210 may send a request to adjust a position within the web page frame for the download to continue from a position three-quarters down the web page frame. Responsive to receiving a download parameter request while downloading a web page, download controller 206 determines the location within the web page file that corresponds to the offsets included in the download parameters, sets the pointer for the download to the new location, and continues to download the web page file from the new location. Client system 210 receives the adjusted download stream and loads the web page from the new position within browser interface 214.

In particular, client system 210 may communicate the download parameter request via multiple types of communication channels. In one example, client system 210 sends the download parameter request as a control signal through a separate control connection supported by the file transfer protocol layer for sending control signals between client system 210 and web server 202. In another example, client system 210 sends the download parameter request as a network packet marked with an out of band (OOB) data flag through the communication channel that client system 210 uses to communicate to web server 202 acknowledgements of receipt of data packets from web server 202. Normally, web server 202 processes the acknowledgement data packets in the order received, however, when a network packet marked with the OOB data flag is received, web server 202 will process that network packet next, out of order. It will be understood that other flags that request processing the network packet with the download parameter request out of order may be set. In addition, it will be understood that other existing communication channels between client system 210 and web server 202 may be used to send the request to adjust the download position within a web page or that a new communication channel may be opened between client system 210 and web server 202 dedicated to communication of requests to adjust the download position within a web page.

In one example, the position within the web page frame indicated in the new download parameter request includes a selectable link to another web page. Once the portions of the web page designated by the new download parameter request are received at client system 210 and output through browser interface 214, the user may then select the selectable link without waiting for a remainder of the web page to load. Once the user selects the link, web browser 212 terminates the current download and requests access to a new web page URL specified in the selectable link.

In one embodiment, a user selects the new download parameters by entering a download priority selection. The download priority selection may be detected by a cursor input within a browser window of browser interface 214, where the cursor input indicates the position within the web page frame that is a priority for the user to see first. In particular, for the user to enter a download priority selection in a browser window of a position that is a priority for downloading, but has not yet downloaded, in one embodiment, the user either knows the layout of the web page contents within the frame from previous visits or an initial portion of the download includes data locators or low resolution images, but not fully selectable links or other information of interest to the user.

In one example, when the user enters a download priority selection by cursor input within a browser window, web browser 212 detects that the cursor is positioned over an image and that the data for a high resolution output of the image be downloaded next from web server 202. In another example, when the user enters a download priority selection by cursor input by sliding an audio or video scroll bar to a new position, web browser 212 requests that web server 202 stream audio or video next, if the audio or video is not already streaming, and requests that web server 202 stream a particular portion of the audio or video next. It will be understood that web browser 212 may detect the user download priority selection of any portion of a web page and send a request for priority download for that portion depending on the type of content of that portion.

In one embodiment, when web server 202 sets the pointer for the download to a particular client system to a new location responsive to a request to adjust the position from the client system, download controller 206 may send stop transmission commands to different software and hardware layers that have already begun pushing a next data packet through web server 202 for transmission to the particular client system. Next, download controller 206 restarts the download from the next location within the web file. It will be understood that in other embodiments, web server 202, as controlled by download controller 206, may issue other commands to handle the transition from the current download parameters to the new download parameters.

Referring now to FIG. 3, a block diagram depicts the interoperation of a web browser within a client system in accordance with the method, system, and program of the present invention. As depicted, operating system 160 facilitates the allocation and use of browser interface 214, where browser interface 214 includes input and output interfaces through peripherals accessible to client system 210. In addition, operating system 160 facilitates allocation and use of network communications channels through communication interface 132. Communication interface 132 may include both software and hardware layers required to facilitate communication channels between operating system 160 and network 102 based on the particular architecture client system 210.

Operating system 160 also facilitates the operations of web browser 212, where web browser 212 is loaded into memory managed by operating system 160. In general, web browser 212 is an application that facilitates web page access and display. In addition, requests for access to web pages are triggered from web browser 212. To access a web page, operating system 160 may open a communication channel via communication interface 132 to communicate with the web server hosting the requested web page. Once the web server is located, the formatting information and contents of the web page are downloaded via the communication channel.

In particular, web browser 212 includes a browser interface controller 304. Browser interface controller 304 controls the formatting of and output of contents into, through operating system 160, a browser window 314 within browser interface 214 and controls responses to user inputs associated with browser window 314 detected from operating system 160. In particular, browser interface controller 304 uses the formatting data received from a web server to establish the web page size or frame. Browser interface controller 304 triggers operating system 160 to open a browser window with scroll bars or other positional display adjusters sized to indicate the web page size for the web page to be downloaded into browser window 314. In addition, browser interface controller 304 directs output of the downloaded web page contents, as received from web server 202, into browser interface 314 and through browser interface 214. It is important to note that browser interface controller 304 may invoke multiple browser windows currently open within browser interface 314, where each browser window displays the web contents of a particular web page and where a separate communication channel is opened with a particular web server or different web servers via network interface 316 for accessing the contents of each web page.

A user may interact with browser window 314 through a cursor based selection or voice command selection, for example. Web browser 212 receives user inputs related to browser window 314 via operating system 160. In particular, according to an advantage, a user makes a download priority selection within browser window 314 while a web page is still downloading into browser window 314 from web server 202. In one example, download priority controller 302 detects a download priority selection when user input indicates that a user positions a cursor in an area within browser window 314 where the content of the downloading web page is not yet completely downloaded and the user indicates a selection at the position of the cursor through depressing a button or other input. In another example, download priority controller 302 detects a download priority selection when user input indicates that a user positions a cursor within a particular area of a downloading web page within browser window 314 and enters a keystroke, voice command or right click that triggers a menu of selectable download priority options. For example, browser interface controller 304 may prompt a user within multiple options including the option to select a tool that enables the user to define the boundaries of a selected area and the option to select a particular quadrant of the web page where the quadrants are defined relative to the horizontal and vertical position of the cursor within the web page frame.

When download priority controller 302 detects a download priority selection by a user while a web page is downloading, download priority controller 302 determines download parameters by calculating offsets within the web page size that describe the position of the priority selection. Download priority controller 302 then sends a request via browser interface 214 to web server 202, where the request for new download parameters includes the offsets as parameters for changing the next portion of the web page downloaded from web server 202 to client system 210. Download priority controller 302 may also select to send a stop command to clear all packets for the web page received by browser interface 214 but not yet loaded into browser window 314.

It is important to note that although operating system 160 and web browser 212 are depicted as separate functional components, operating system 160 and web browser 212 may be integrated within a single software system. In addition, it is important to note that multiple disparate web browser applications may concurrently execute within client system 210.

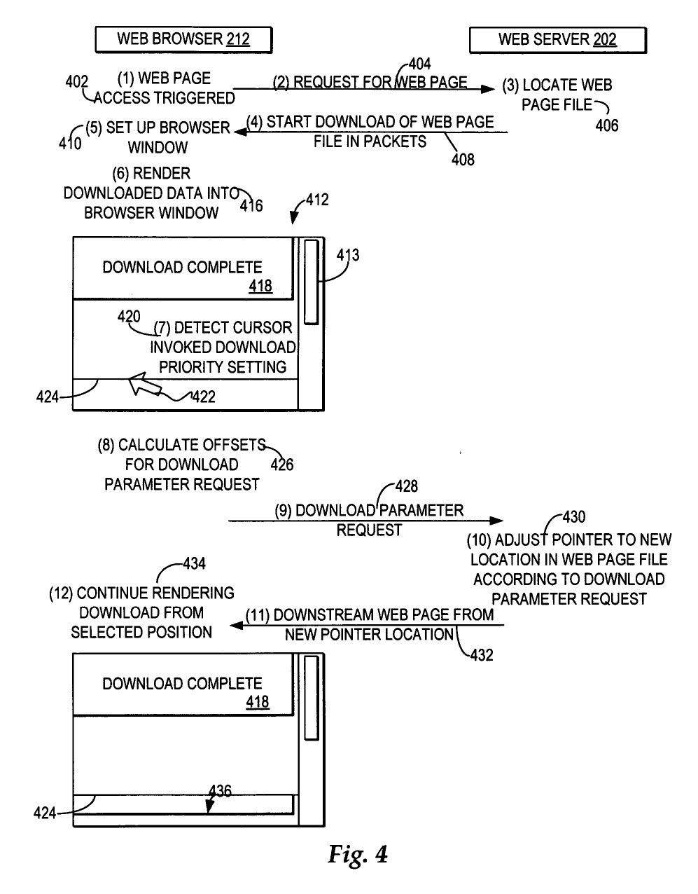

With reference now to FIG. 4, an illustrative diagram shows one example of the flow of data between a web browser and a web server where user specified download priority is enabled in accordance with the method, system, and program of the present invention. In the example, client system 210 communicates with web server 202 via network 102. In particular, the data transfer between web browser 212 executing on client system 210 and web server 202 is depicted in the example.

In the example, as depicted at reference numeral 402, a web page access is triggered. A web page access may be triggered in multiple ways including, but not limited to, a user entering a URL for a web page and requesting access to that URL, a user selecting a bookmark of a URL, and a user opening a browser window where opening a browser window automatically triggers a request for access to a web page URL designated as a home page.

Responsive to the web page access trigger, web browser 212 sends a request for the web page to web server 202, as illustrated at reference numeral 404. Although not depicted, it will be understood that in one embodiment, web browser 212 may submit the request to a network which locates web server 202 and routes the request to web server 202. Additionally, although not depicted, it will be understood that web server 202 may open a socket or thread for communication with client system 210 and perform additional steps to establish communication between web server 202 and client system 210 which are dependent upon the architecture of web server 202.

As illustrated at reference numeral 406, web server 202 locates the requested web page file. Next, as illustrated at reference numeral 408, web server 202 starts downloading the web page file in packets, blocks or other units. In particular, the web page download includes formatting information which web browser 212 receives and uses to set up browser window 412, as illustrated at reference numeral 410. In particular, in setting up browser window 412 within a browser interface, web browser 212 determines the size of the web page in terms of the boundaries of the graphical area that the web page will fill and sets up browser window 412 to handle the boundaries of the graphical area in comparison to the size of browser window 412. In one example, the length of a scroll bar 413 within browser window 412 is adjusted to indicate the boundaries of the web page and enable the user to vertically scroll through the web page by adjusting the position of scroll bar 413.

After web browser 212 sets up browser window 412, web browser 212 begins to render downloaded data into browser window 412, as illustrated at reference numeral 416. In particular, within browser window 412, the web page file data is sequentially received and shaded area 418 of browser window 412 indicates the portion of the web page file already read into browser window 412.

While the web page file data is read from web server 202 into browser window 212, a user makes a download priority selection, detected by web browser 208 as illustrated at reference numeral 420. In the example, the user makes a download priority selection by positioning cursor 422 within browser window 412 and entering a selection, such as a click entry. Responsive to the entry, web browser 208 detects a horizontal position 424 within browser window 412 at which the click was made. Next, as illustrated at reference numeral 426, web browser 208 calculates web page offsets for the selected position within the web page boundaries for the download parameter request. In the example, the offset for the location indicated by horizontal position 424 might be calculated as a number of pixels, a length in centimeters or inches, or other units of measurement that indicate download priority selection. Further, download parameters that indicate a position may include horizontal and vertical offsets and may include upper and lower offsets.

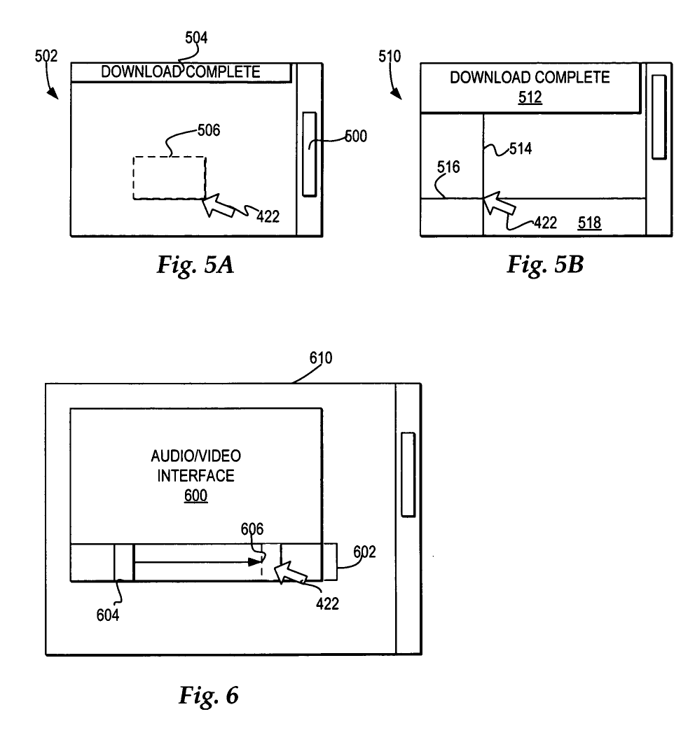

While FIG. 4 depicts one embodiment of a download priority selection by a user through a horizontal offset, FIG. 5A illustrates another example of a type of download priority selection by a user through a selection of a range of a browser window. In the example in FIG. 5A, a web page file being downloaded is currently rendering within browser window 502; the completed portion of the download is illustrated at reference numeral 504. A user adjusts the position of scroll bar 500 to adjust the portion of the web page frame visible within browser window 502. Next, a user enters a download priority selection using cursor 422 to select a particular area 506. In one example, a user is enabled to select area 506 by entering a right-click that triggers a box tool and then dragging cursor 422 to set the size of the box that defines area 506. Web browser 212 calculates offsets for the download parameter request that describe the region designated by area 506. In yet another example of a type of download priority select by a user, FIG. 5B illustrates a selection of a quadrant of browser window 510. In the example, a web page file being downloaded is currently rendering within browser window 510; the completed portion of the download is illustrated at reference numeral 512. A user enters a download priority selection by positioning cursor 422 and entering a selection of a quadrant. In particular, based on the position of cursor 422, four quadrants may are created by a horizontal position 516 and a vertical position 514. A user may designate one of the four quadrants through a pull down menu invoked when a user right clicks or through another input. In the example, the user selects the quadrant indicated at reference numeral 518. In addition, although not depicted, a user may select a multiple quadrants, such as the two quadrants to the right of the vertical position 514.

As depicted at reference numeral 428, web browser 212 passes the offsets indicating the position to web server 202 in a download parameter request. Web server 202 receives the download parameter request while continuing to send the web page file to web browser 212 and as illustrated at reference numeral 230, web server 202 adjusts a pointer to a new location in the web page file according to the offsets in the download parameter request. Next, as illustrated at reference numeral 432, web server 202 continues to send the web page file from the new location within the web page file. In one example, web server 202 moves a pointer at the current download location to a new location according to the offsets and then continues to stream the data from the new pointer location. Web browser 208 continues to read the web page file sent from web server 202 from the offset position within browser window 412. In the example, the download of data into web browser 412 continues sequentially from horizontal position 412 as illustrated by the shaded area at reference numeral 436.

In particular, it is important to note that a download parameter request may include offsets for a particular position within browser window 412 and an additional specification of the type of information requested. For example, a download parameter request may include offsets for a particular position within browser window 412 and a request to render the position next and to render the image at the position at a high resolution. In another example, a download parameter request may include offsets for a particular position within browser window 412 and a specification that the offset is within an audio interface and indicates an offset within an audio stream.

For example, FIG. 6 is an illustrative diagram of a portion of a browser window with an audio and video interface. As illustrated, an audio/video interface 600 within a browser window 610 includes a streaming bar 602 with a slider 604 that indicates the amount within a total audio or video stream that is currently buffered from among a total stream size. In one example, web server 202 streams audio or video to web browser 212 and web browser 212 buffers the audio or video stream. A particular percentage of the audio or video may be buffered before the user can select to play the audio or video or web browser 212 may select to automatically start play once the percentage of audio or video is already buffered.

According to an advantage, a user makes an audio or video stream download priority selection by adjusting the position of slider 604 ahead of the current play position. For example, the user adjusts the position of slider 604 using cursor 520 to drag and drop slider 604 from a first position to the position indicated at reference numeral 606. Web browser 208 calculates an offset of the new slider position within the total stream size from the start of the stream and sends a request for parameter adjustment of the currently streaming audio or video to the position requested. In another example, web browser 208 may request a parameter adjustment of the currently streaming audio or video based on an offset calculated from the end of the stream. It will be understood that other calculations of offsets for an audio or video stream may be implemented depending on the required buffer size of the stream before play can begin.

It is important to note that, in one example, a user may first, through cursor selection, make a download priority selection for a web page data download to jump to the position of the audio/video interface 600. Once audio/video interface 600 is displayed, then the user may select a download priority selection for the audio or video stream selectable through audio/video interface 600, where the download priority selection requests that the audio stream next from the position represented at reference numeral 606.

Referring now to FIG. 7, a high level logic flowchart depicts a process and program for a web browser response to user download priority selections. As illustrated, the process starts at block 700 and thereafter proceeds to block 702. Block 702 depicts a determination whether the web browser detects a user selection of a download priority while a web page is still downloading from a web server. If the user selection of a download priority is detected while the web page is still downloading, then the process passes to block 704. Block 704 illustrates calculating offsets within the web page based on the download priority selection. Next, block 706 depicts outputting the offsets in a download parameter request to the web server during the download, and the process ends. It will be understood that a separate process controls the web browser receipt of a web page download and rendering of the web page download within a browser interface.

With reference now to FIG. 8, a high level logic flowchart depicts a process and program for a web server response to a download parameter request for a currently downloading web page. As illustrated, the process starts at block 800 and thereafter proceeds to block 802. Block 802 depicts a determination whether the web server receives a download parameter request from a client system to which a web page is currently downloading. If the web server receives a new download parameter request then the process passes to block 804. Block 804 illustrates adjusting the pointer to a new location within the web file according to the offsets in the download parameter request. Next, block 806 depicts continuing to download the web page file to the requesting client from the new pointer location. It is important to note that the offsets may include both horizontal and vertical offsets and that the web server may make multiple adjustments to the pointer location to give priority to downloading the portion of the web page indicated in the download parameters request. Thereafter block 808 illustrates a determination whether when the pointer reaches the end of the web page file and the client system is still connected. If the pointer reaches the end of the web page file and the client system is still connected, then the process passes to block 808. Block 808 depicts adjusting the pointer location to download the remainder of the web page file and next block 810 illustrates continuing downloading of the remainder of the web page file, and the process ends. Otherwise, at block 806, if the pointer does not reach the end of the web page file or it reaches the end and there is a stop request, then the process ends.

While the invention has been particularly shown and described with reference to a preferred embodiment, it will be understood by those skilled in the art that various changes in form and detail may be made therein without departing from the spirit and scope of the invention.

What is claimed is:

1. A method for enabling user selection of a priority of a portion of a web page to download after a download starts, comprising:
detecting receipt, at a client system, of a first portion of data from among a plurality of portions of data for specifying a web page, wherein said client system is communicatively connected via a network to a server system that downloads said web page by sequentially sending each of said plurality of portions of data that specify said web page;
controlling, as said client system receives said first portion of data, display of said first portion of data within a window area of a user interface formatted for displaying said web page;
responsive to detecting, while said client system is still communicatively connected to said server system and receiving said first portion of data, a selection by a user of a particular position within said window area, automatically sending a request to said server system to adjust said download to send a next portion of data from among said plurality of portions of data, wherein said next portion of data specifies said particular position within said window area;
responsive to receiving, at said server system, said request to adjust to said download at said server system, adjusting, said next portion of data from among said plurality of portions of data of said web page downloaded from said server system to said client system to comprise said particular position within said window area, such that as said web page is received at said client system a user at said client system is enabled to designate a priority of said particular position to be received next during said download of said web page.

2. The method for enabling user selection of a priority according to claim 1, wherein detecting receipt, at a client system, of a first portion of data from among a plurality of portions of data for specifying a web page further comprises:
receiving said first portion of data comprising at least one packet of data via said network, wherein said network is a packet switching network.

3. The method for enabling user selection of a priority according to claim 1, wherein detecting, while said client system is still communicatively connected to said server system and receiving said first portion of data, a selection by a user of a particular position within said window area further comprises:
detecting a position of said cursor within said window area and a selection by said user of said position of said cursor; and
specifying said particular position based on a horizontal offset of said position of said cursor from a top edge of said window area.

4. The method for enabling user selection of a priority according to claim 1, wherein detecting, while said client system is still communicatively connected to said server system and receiving said first portion of data, a selection by a user of a particular position within said window area further comprises:
detecting a selection by said user to open a menu of a plurality of selectable positions;
responsive to said selection of said menu trigger input, displaying said menu of said plurality of selectable positions within said window area; and
detecting a user selection from among said menu of said plurality of selectable positions as said particular position.

5. The method for enabling user selection of a priority according to claim 1, wherein detecting, while said client system is still communicatively connected to said server system and receiving said first portion of data, a selection by a user of a particular position within said window area further comprises:
detecting an adjustment of a position of a selection indicator within an audio transmission bar while audio represented by said position within said audio transmission bar is not yet streamed to said client system from said server system, wherein said position of said selection indicator along said audio transmission bar indicates a current play location for said audio stream; and
responsive to detecting said adjustment of said position of said selection indicator, specifying said particular position by an offset of said position within said audio transmission bar.

6. The method for enabling user selection of a priority according to claim 1, wherein detecting, while said client system is still communicatively connected to said server system and receiving said first portion of data, a selection by a user of a particular position within said window area further comprises:
detecting a position of a cursor within said window area and a selection by said user of said position of said cursor;
detecting that said position of said cursor is pointing to a graphical image area; and
specifying said particular position by an offset of said position of said cursor and by a request for a high resolution output at said position of said cursor.

7. The method for enabling user selection of a priority according to claim 1, further comprising:
receiving, at said client system, said next portion of data specifying said particular position within said window area; and
controlling, as said client system receives said next portion of data, display of said next portion of data within said window area in said particular position.

8. A system for enabling user selection of a priority of a portion of a web page to download after a download starts, comprising:
a client system running a browsing application and accessing at least one server system via a computer network;
said browsing application for detecting receipt of a first portion of data from among a plurality of portions of data for specifying a web page from said server system, wherein said server system downloads said web page to said client system by sequentially sending each of said plurality of portions of data that specify said web page;
said browser application for facilitating a user interface, wherein as said browser application detects receipt of said first portion of data, said first portion of data is displayed within said user interface within a window area formatted for displaying said web page, wherein a user interacts with said user interface to select a particular position within said window area that invokes said browser application to send a request to said server system to adjust said download to send a next portion of data from among said plurality of portions of data comprising said particular position, wherein as said browser detects receipt of said next portion of data, said next portion of data is displayed within said window area in said particular position.

9. The system for enabling user selection of a priority according to claim 8, wherein said computer network is a packet switching network and wherein said first portion of data comprises at least one network packet of data.

10. The system for enabling user selection of a priority according to claim 8, further comprising:
responsive to said user entering a cursor selection, said browser application detecting a position of said cursor within said window area of said user interface when said user enters said cursor selection; and
said browser application sending said request to said server system to adjust said download where said particular position is based on a horizontal offset of said position of said cursor from a top edge of said window area.

11. The system for enabling user selection of a priority according to claim 8, further comprising:
responsive to said user selecting within said user interface to open a menu of selectable positions within said user interface, said browser application triggering a display of said menu of said plurality of selectable positions within said window area; and
responsive to said browser application detecting a particular selectable position by said user from among said plurality of selectable positions, said browser application sending said request to said server system to adjust said download where said particular position is said particular selectable position.

12. The system for enabling user selection of a priority according to claim 8, further comprising:
said user interface displaying an audio transmission bar within said window area, wherein an audio stream represented by said position within said audio transmission bar is not yet completely streamed to said client system from said server system, wherein a position of a selection indicator along said audio transmission bar indicates a current play location for said audio stream; and
responsive to said user adjusting said position of a selection indicator along said audio transmission bar within said user interface, said browser application sending said request to said server system to adjust said download where said particular position is an offset of said adjusted position of said selection indicator along said audio transmission bar.

13. The system for enabling user selection of a priority according to claim 8, further comprising:
responsive to said user entering a cursor selection, said browser application detecting a position of said cursor within said window area of said user interface when said user enters said cursor selection and detecting whether said cursor is positioned pointing to a graphical image area; and
responsive to said browser application detecting that said cursor is positioned pointing to a graphical image area, said browser application sending said request to said server system to adjust said download where said particular position is an offset of said position of said cursor and a request for a high resolution output at said position of said cursor.

14. The system for enabling user selection of a priority according to claim 8, further comprising:
said browser application sending said request to said server system to adjust said download via at least one from among a download control signal via a transmission control specified communication channel between said client system and said server system and a network packet specified to be processed next by said server system when received at said server system via an acknowledgement communication channel.

15. A program for enabling user selection of a priority of a portion of a web page to download after a download starts, said program embodied in a computer-readable medium, said program comprising computer-executable instructions which cause a computer to perform the steps of:
detecting receipt of a first portion of data from among a plurality of portions of data for specifying a web page, wherein said computer is communicatively connected via a network to a server system that downloads said web page by sequentially sending each of said plurality of portions of data that specify said web page;
controlling, as said computer receives said first portion of data, display of said first portion of data within a window area of a user interface formatted for displaying said web page;
responsive to detecting, while said computer system is still communicatively connected to said server system and receiving said first portion of data, a selection by a user of a particular position within said window area, automatically sending a request to said server system to adjust said download to send a next portion of data from among said plurality of portions of data, wherein said next portion of data specifies said particular position within said window area;

16. The program for enabling user selection of a priority according to claim 14, wherein detecting, while said computer system is still communicatively connected to said server system and receiving said first portion of data, a selection by a user of a particular position within said window area further comprises:
detecting a position of said cursor within said window area and a selection by said user of said position of said cursor; and
specifying said particular position in said request based on a horizontal offset of said position of said cursor from a top edge of said window area.

17. The program for enabling user selection of a priority according to claim 14, wherein detecting, while said computer system is still communicatively connected to said server system and receiving said first portion of data, a selection by a user of a particular position within said window area further comprises:
detecting a selection by said user to open a menu of a plurality of selectable positions;
responsive to said selection of said menu trigger input, displaying said menu of said plurality of selectable positions within said window area; and
detecting a user selection from among said menu of said plurality of selectable positions as said particular position in said request.

18. The program for enabling user selection of a priority according to claim 14, wherein detecting, while said computer system is still communicatively connected to said server system and receiving said first portion of data, a selection by a user of a particular position within said window area further comprises:
detecting an adjustment of a position of a selection indicator within an audio transmission bar while audio represented by said position within said audio transmission bar is not yet streamed to said computer system from said server system, wherein said position of said selection indicator along said audio transmission bar indicates a current play location for said audio stream; and
responsive to detecting said adjustment of said position of said selection indicator, specifying said particular position in said request by an offset of said position within said audio transmission bar.

19. The program for enabling user selection of a priority according to claim 14, wherein detecting, while said computer system is still communicatively connected to said server system and receiving said first portion of data, a selection by a user of a particular position within said window area further comprises:
detecting a position of a cursor within said window area and a selection by said user of said position of said cursor;
detecting that said position of said cursor is pointing to a graphical image area; and
specifying said particular position in said request by an offset of said position of said cursor and by a request for a high resolution output at said position of said cursor.

20. The program for enabling user selection of a priority according to claim 14, further comprising:
receiving, at said computer system, said next portion of data specifying said particular position within said window area; and
controlling, as said computer system receives said next portion of data, display of said next portion of data within said window area in said particular position.
